(19) United States
(12) Patent Application Publication
(10) Pub. No.: US 2004/0252228 A1
(43) Pub. Date: Dec. 16, 2004

(54) Multiple-screen display and a method of controlling the same

(75) Inventors: Mitsuji Waki, Hachioji-City (JP); Takanori Ishizawa, Tachikawa City (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/802,140

(22) Filed: Mar. 17, 2004

(30) Foreign Application Priority Data
Apr. 2, 2003 (JP) 2003-99264

(51) Int. Cl. H04N 11/02

(52) U.S. Cl. 348/383; 348/189

(57) ABSTRACT

A multiple-screen display and a method of controlling the same capable of controlling the image display device automatically and promptly, without being not influenced by the installation site, and capable of dealing also with the modification of a combination of image display devices easily, are provided. A characteristic data memory 11, a compensation data memory 12, and a video signal correction processing unit 13, corresponding to respective image display devices 1, and a compensation data calculator common with N image display devices 1, are provided, the characteristic data of the corresponding image display device 1 are stored in the characteristic data memory 11, the compensation data calculator calculates the compensation data of respective image display devices 1, collectively, based on the characteristic data stored in all characteristic data memory 11, to store these compensation data in the corresponding compensation data memory 12, and the input video signals are displayed by compensating and processing them in respective image display devices 1, by the video signal correction processing unit 13, based on the compensation data stored in the corresponding compensation data memory 12.

### BACKGROUND OF INVENTION

1. Field of the Invention

The present invention relates to a multiple-screen display constituting one screen by combining a plurality of image display devices and a method of controlling the same.

2. Description of Related Art

Such a kind of multiple-screen display is for example widely used at an event hall and a showroom or the like, because of shorter depth and higher luminance than those of the large screen monitor unit.

In such a multiple-screen display, irregular luminance and irregular color (intra-screen irregular) in the display screen in respective image display devices, and irregular luminance and irregular color (inter-screen irregular) between display screens become a problem on observing the image.

As the main factor of such scattering, in the case of having the projector in the image display device, a scattering of the light filter, a scattering of the lamp being the projection light source, and those variation per hour etc. are nominated, in addition, in the case of being a liquid crystal projector as the projector the scattering of the liquid crystal panel and its variation per hour etc. are nominated.

As a method of resolving this problem, for example, there is a method of selecting the image display device with a similar characteristic at factory shipment, to combine the selected image display devices, thereby constituting a multiple-screen display. In this method, however, there are problems that the image display devices plural times the number of image display device to be required, must be prepared, and the number of the image display devices necessary to find an excellent combination does not have the foggiest, and thus the working number of man-hours can not be estimated.

Moreover, as other resolution processes, there is a method of adjusting the color and luminance of respective image display devices after building in the necessary number of the image display device. In this case, however, there is a problem that the quality is not steady depending on the worker, because of requiring skill for the adjustment, and there is a problem that the more the number of the image display device is increased, the more the mutual adjustment between the image display devices becomes hard, thereby taking time consume.

Then, there is proposed that as a method of resolving the above problem, a data converter for converting a video signal data converted digitally into a video signal data with the corrected irregular luminance, and an arithmetic and control unit for controlling the content of the conversion process in data converter, are provided in respective image display devices, first, the screen is made a constant luminance and the irregular luminance in the screen is corrected in respective image display devices, afterwards, the operation for correcting the irregular luminance between screens, is repeated by a plurality of luminance (for example, 100%, 75%, 50%, and 25%), so as to lost the luminance difference between image display devices in said luminance, thereby correcting irregular luminance and irregular color in all luminance levels (for example, refer to Japanese Patent Number 327,007).

Moreover, as other resolution processes, there is proposed that first, respective colors of R, G, and B are displayed on the multiple-screen display consisting of plural image display devices, the light quantity data of respective colors are detected, by capturing the screen with the camera, the intra-screen irregular is corrected every image display devices, based on the detected light quantity data, next, the white balance between image display devices is adjusted by controlling the driving voltage of respective image display devices, finally, the inter-screen irregular is corrected by adjusting the γ characteristic (for example, refer to Japanese Patent Application Opened No. 333,760/1995).

However, in the controlling method disclosed in Japanese Patent number 327007, there is required the adjustment in multiple steps that the inter-screen irregular is corrected, after the correction of the intra-screen irregular is performed in each luminance. Moreover, in the controlling method disclosed in Japanese Patent Application Opened No. 333,760/1995, there is required the adjustment in 3 steps that after the correction of the intra-screen irregular is performed, a white balance of the inter-screen is adjusted, and γ adjustment is 04005 (2003-99,264) performed, finally, moreover, even in each controlling method, every time the combination of the image display devices is changed, the same adjustment is necessary to reattempt from the beginning, so that there is a problem of taking manpower and time.

Moreover, the adjustment is performed, after the multiple image display devices are assembled, so that when the screen of the multiple-screen display is captured with the camera, and the irregular luminance is corrected based on the data, the camera can not be installed depending on the installation site of the multiple-screen display, and the installation environment cannot be made a darkroom, and thus there is a case that can not be corresponded to, too.

### SUMMARY OF THE INVENTION

Therefore, the present invention performed by paying an attention to this respect, has for its object to provide a multiple-screen display capable of controlling the image display device automatically and promptly without being influenced by the installation site, and capable of dealing also with modification in combination of image display devices easily and a method of controlling such a multiple-screen display.

To this end, according to the present invention there is provided a multiple-screen display having one-screen constituted by combining plural N of image display devices, comprising a characteristic data memory means, a compensation data memory means, and a video signal correction processing means, corresponding to respective image display devices, and a compensation data calculator means common with plural N of image display devices, the characteristic data of the corresponding image display device being stored in the characteristic data memory means, the compensation data calculator means being constituted in such a manner that the compensation data of respective image display devices are calculated collectively, based on the characteristic data stored in all characteristic data memory means, to store these compensation data in the corresponding compensation data memory means, and the input video signals being displayed by compensating and processing them in respective image display devices, by the video signal correction processing means, based on the compensation data stored in the corresponding compensation data memory means.

According to the present invention, there is provided a multiple-screen display having one-screen constituted by combining plural N of image display devices, comprising a characteristic data memory means, a compensation data calculator means, a compensation data memory means, a communication means and a video signal correction processing means, corresponding to respective image display devices, the characteristic data of the corresponding image display device being stored in the characteristic data memory means, all image display devices being able to be connected with mutual communicable through the communication means, the compensation data calculator means is constituted in such a manner that the characteristic data stored in the characteristic data memory means of all image display devices are taken in, and the compensation data of the corresponding image display means are calculated based on these characteristic data, to store these compensation data in the compensation data memory means, and the input video signals being displayed by compensating and processing them in respective image display devices, by the video signal correction processing means, based on the compensation data stored in the corresponding compensation data memory means.

According to the present invention there is provided a multiple-screen display having one-screen constituted by combining plural N of image display devices, comprising a compensation data memory means, a video signal correction processing means and a portable record carrier, corresponding to respective image display devices, and a compensation data calculator means having a record carrier reading function and common with N image display devices, the characteristic data of the corresponding image display device and the identification code of said image display device are recorded in the record carrier, the compensation data calculator means is constituted in such a manner that the compensation data of respective image display devices are calculated collectively, based on the characteristic data obtained by reading all record carriers and identification codes, to store these data and codes in the corresponding compensation data memory means, and the input video signals being displayed by compensating and processing them in respective image display devices, by the video signal correction processing means, based on the compensation data stored in the corresponding compensation data memory means.

According to the present invention there is provided a multiple-screen display having one-screen constituted by combining plural N of image display devices, comprising a compensation data memory means, and a video signal correction processing means, corresponding to respective image display devices, a data base accessible through the network, and a compensation data calculator means capable of being connected to the networks and common with the N image display devices, the characteristic data of respective image display devices and the identification code of said image display device are recorded in the data base, the compensation data calculator means is constituted in such a manner that the compensation data of respective image display devices are calculated collectively, to store the compensation data in the compensation data memory means, based on the read information obtained by reading all characteristic data and identification codes from the data base through the network, and the input video signals being displayed by compensating and processing them in respective image display devices, by the video signal correction processing means, based on the compensation data stored in the corresponding compensation data memory means.

According to the present invention there is provided a multiple-screen display having one-screen constituted by combining plural N of image display devices, comprising a compensation data memory means, and a video signal correction processing means, corresponding to respective image display devices, a data base accessible through the network, and a compensation data calculator means capable of being connected to the networks and common with the N image display devices, the characteristic data of respective image display devices and the identification code of said image display device are recorded in the data base, the compensation data calculator means is constituted in such a manner that the compensation data of respective image display devices are calculated collectively, to store the compensation data in the compensation data memory means, based on the read information obtained by reading all characteristic data and identification codes from the data base through the network, and the input video signals being displayed by compensating and processing them in respective image display devices, by the video signal correction processing means, based on the compensation data stored in the corresponding compensation data memory means.

According to the present invention there is provided a multiple-screen display having one-screen constituted by combining plural N of image display devices, comprising a characteristic data memory means, a compensation data memory means, and a video signal correction processing means, corresponding to respective image display devices, a layout information memory means for storing the layout information showing the layout position of the N image display devices, a compensation data calculator means common with N image display devices, the characteristic data of the corresponding image display device being stored in the characteristic data memory means, the compensation data calculator means is constituted in such a manner that the compensation data of respective image display devices are calculated collectively, based on the characteristic data and layout information stored in all characteristic data memory means and the layout information memory means, respectively, to store these compensation data and layout information in the corresponding compensation data memory means, and the input video signals being displayed by compensating and processing them in respective image display devices, by the video signal correction processing means, based on the compensation data stored in the corresponding compensation data memory means.

In a multiple-screen display according to the present invention, the identification codes of respective image display devices are stored in the layout information memory means.

In a multiple-screen display according to the present invention, the characteristic data sequentially displays a specific image to the corresponding image display device by different luminance, and the characteristic of the respective display images is displayed by the image characteristic detecting means.

In a multiple-screen display according to the present invention, the image characteristic detecting means contains any one of a CCD camera, a video camera, a colorimeter and a photo-electronic sensor.

In a multiple-screen display according to the present invention, the characteristic data has the luminance value at plural input levels including 100% luminance and 0% luminance of respective colors of red (R), green (G), and blue (B) at every the block obtained by dividing the corresponding display area of the image display device into a plurality of blocks, the compensation data calculator means calculates the compensation data of respective colors of respective blocks collectively in such a manner that when the minimum values at 100% luminance of respective colors in k (k=1-N)th image display device are assumed to be R-White(k), G-White(k), and B-White(k), and the maximum values at 0% luminance are assumed to be R-Black(k), G-Black(k), and B-Black(k), minimum values R-Whitemin, G-Whitemin, and B-Whitemin of R-White(k), G-White(k), and B-White(k), (k=1-N), and maximum values R-Blackmax, G-Blackmax, and B-Blackmax of R-Black(k), G-Black(k), and B-Black(k), (k=1-N), are extracted, and in the case of R-Whitemin, G-Whitemin, and B-Whitemin at 100% luminance of a respective color of a respective image display device, and in the case of R-Blackmax, G-Blackmax, and B-Blackmax, at 0% luminance, a required y characteristic curve is obtained.

In a multiple-screen display according to the present invention, the given characteristic curve is an average γ characteristic curve, in case of correcting the R-Blackmax, G-Blackmax, and B-Blackmax as lower limit, and in case of correcting the R-Whitemin, G-Whitemin, and B-Whitemin as upper limit.

In a multiple-screen display according to the present invention, the R-Whitemin, G-Whitemin, and B-Whitemin and/or the R-Blackmax, G-Blackmax, and B-Blackmax are made equal. In a multiple-screen display according to the present invention, the compensation data calculation means calculates the compensation data in such a manner that the γ characteristic curve are made equal at the left end and the right end and the upper end and the lower end of the display screen of respective image display devices.

According to the present invention there is provided a method of controlling a multiple-screen display having one-screen constituted by combining plural N of image display devices, comprising: a step of storing characteristic data obtained by capturing the screen of respective image display devices displayed by the test image previously, a step of calculating the compensation data of respective image display devices based on the characteristic data of the N image display devices after the layout of the plural N of image display devices, and a step of setting the calculated compensation data to respective image display devices. As described above, according to the present invention, after obtaining the characteristic data of all image display devices constituting one screen, the compensation data of respective image display devices are collectively calculated based on those characteristic data, so that the characteristic data can be obtained without being influenced by the installation site, and respective image display devices can be controlled automatically and promptly, and also the modification in the combination of image display devices can be dealt with easily.

### BRIEF DESCRIPTION OF THE DRAWING

FIG. 1 is a partially exploded perspective view showing a constitution of a multiple-screen display according to first embodiment of the present invention,

FIG. 2 is a view showing the utilizing mode of the multiple-screen display,

FIG. 3 is a block diagram showing the constitution of an operating control unit shown in FIG. 2,

FIG. 4 is a flow chart showing the acquisition step of the compensation data according to the first embodiment,

FIG. 5 is a view showing a schematic constitution for acquiring the characteristic data and the compensation data according to the first embodiment,

FIG. 6 is an explanatory view explaining a method for acquiring the characteristic data according to the first embodiment,

FIG. 7 is a view showing an embodiment of a block division on the screen display area for explaining the characteristic data obtaining method, similarly,

FIG. 8 is a view showing one embodiment of the characteristic data,

FIG. 9 is a flow chart explaining a method of calculating the compensation data according to the first embodiment,

FIG. 10 is a view showing one embodiment of the correction characteristic data in the calculation process of the compensation data, similarly,

FIG. 11 is a view for explaining the correction effect according to the first embodiment,

FIG. 12 is a view explaining the corrected effect, similarly,

FIG. 13 is a block diagram showing the construction of an operating control unit used in the second embodiment of the present invention,

FIG. 14 is a view explaining a method for acquiring the characteristic data according to the second embodiment,

FIG. 15 is a block diagram showing the construction of an operating control unit used in the third embodiment of the present invention,

FIG. 16 is a block diagram showing the construction of an operating control unit used in the fourth embodiment of the present invention, similarly,

FIG. 17 is a view explaining the fifth embodiment according to the present invention,

FIG. 18 is a view explaining the sixth embodiment, similarly,

FIG. 19 is a view explaining the seventh embodiment, similarly,

FIG. 20 is a view explaining the eighth embodiment, similarly,

FIG. 21 is a view showing the recorded content of the mounting information storage section shown in FIG. 20,

FIG. 22 is a view explaining the contrast in case of calculating the compensation data from all characteristic data in FIG. 20,

FIG. 23 is a view explaining the contrast according to the eighth embodiment,

FIG. 24 is a view explaining the displayed conditions of one image display device,

FIG. 25 is a view showing the illuminance distribution of the plural image display devices,

FIG. 26 is a view explaining a method for calculating the characteristic data according to the ninth embodiment of the present invention,

FIG. 27 is a view explaining the calculating method, similarly, and

FIG. 28 is a view explaining the calculating method, similarly.

### DETAILED DESCRIPTION OF THE PREFERRED EMBODIMENTS

Hereafter, the embodiment of the multiple-screen display and its controlling method according to the present invention are explained referring to the drawing.

### First Embodiment

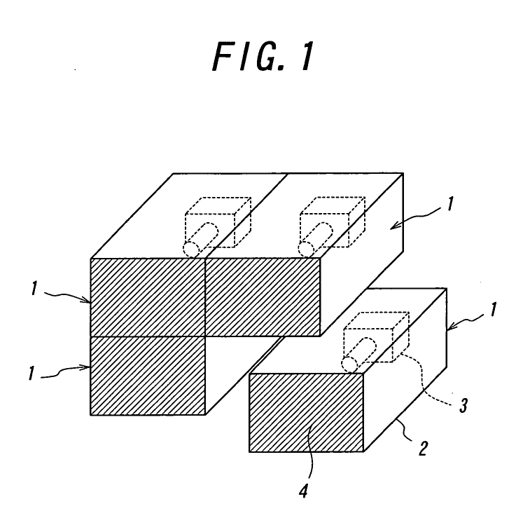

FIG. 1 is a partially exploded perspective view showing a constitution of a multiple-screen display according to first embodiment of the present invention. The multiple-screen display is constituted by combining plural N (Here, N=4) of the image display devices 1 by two up and down directions, and respective image display devices 1 have a projector 3 arranged in a hexahedron casing 2 and a screen 4 (display screen) arranged in front of the casing 2 so as to display the projected image.

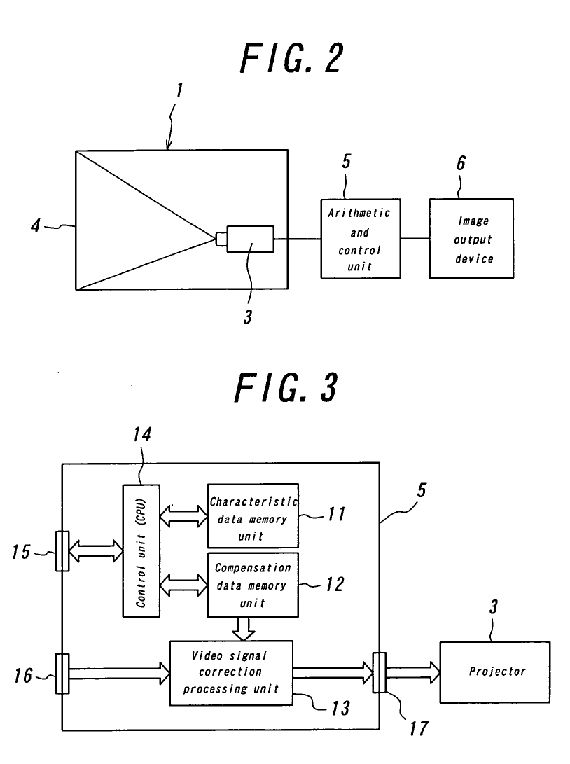

In this embodiment, as shown in FIG. 2, an arithmetic and control unit 5 is provided in respective image display devices 1, the video signal output from an image output equipment 6 such as personal computers and video players by the arithmetic and control unit 5, is corrected and processed, and the images are projected from a projector 3 to a screen 4 as one-screen constituted by four image display devices 1.

The arithmetic and control unit is provided with, as shown in FIG. 3, a characteristic data memory unit 11, a compensation data memory unit 12, a video signal correction processing section 13, a control unit (CPU) 14, a communication section 15, a video signal input circuit 16, and a video signal output section 17. The characteristic data memory unit 11 and the compensation data memory unit 12 enable a read and write of a control unit described later and the data through the control unit 14 and the communication section 15, the characteristic data of the corresponding image display device 1 are stored in the characteristic data memory unit 11, and the compensation data of the image display device 1 are stored in the compensation data memory unit 12.

In this way, the input video signal inputted from the image output equipment 6 through the video signal input circuit 16 is corrected and processed in real time, based on the compensation data stored in the compensation data memory unit 12 in the video signal correction processing unit 13, and the corrected video signals are supplied to the corresponding projector 3 from the video signal output section 17, thereby projecting and displaying them on the screen 4.

Moreover, the characteristic data memory unit 11 and the compensation data memory unit 12 may be constituted by a nonvolatile memory (for example, flash memory), or, may be constituted by using volatile memory (SDRAM) in such a manner to back up with the battery and that data is not lost even if the power supply is turned off. Particularly, as to the compensation data memory unit 12, the input video signal is corrected and processed in real time by referring to the compensation data in the video signal correction processing unit 13, so that preferably, a nonvolatile memory and a volatile memory are used, the compensation data is always stored in the nonvolatile memory having a comparatively slow processing rate, and the compensation data is downloaded from the nonvolatile memory to a volatile memory having a comparatively fast processing rate at power-on operation.

Next, a method of obtaining the characteristic data stored in the characteristic data memory unit 11, and a method of calculating the compensation data stored in the compensation data memory unit 12, are explained.

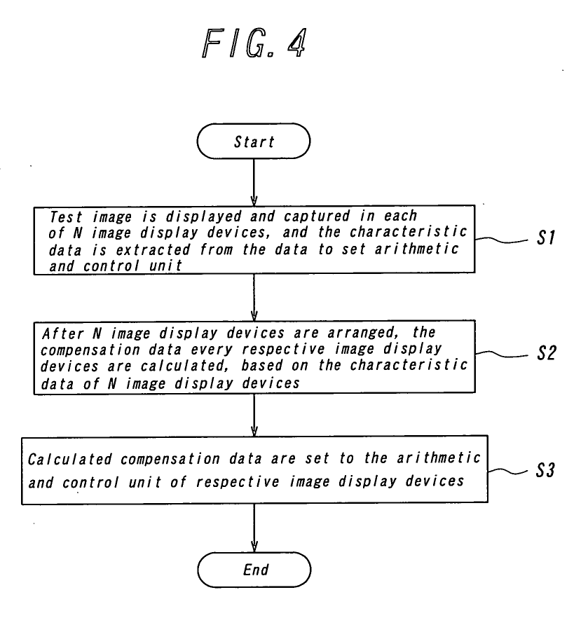

In this embodiment, as shown in FIG. 4, first, the test image (specific image) is displayed in each of N image display devices 1 (here, N=4), the displayed test image is captured, and the characteristic data is extracted from the captured data and is stored in the characteristic data memory unit 11 of the arithmetic and control unit 5 (step S1). Next, N image display devices 1 are arranged, the characteristic data obtained already been obtained and stored in the characteristic data memory unit 11 of N arithmetic and control units 5, are taken in, and the compensation data for correcting the intra-screen irregular of the respective image display devices 1 and the inter-screen irregular between image display devices 1, are collectively calculated based on those characteristic data (step S2). Afterwards, the calculated compensation data is stored in the compensation data memory unit 12 of the corresponding arithmetic and control unit 5 (step S3).

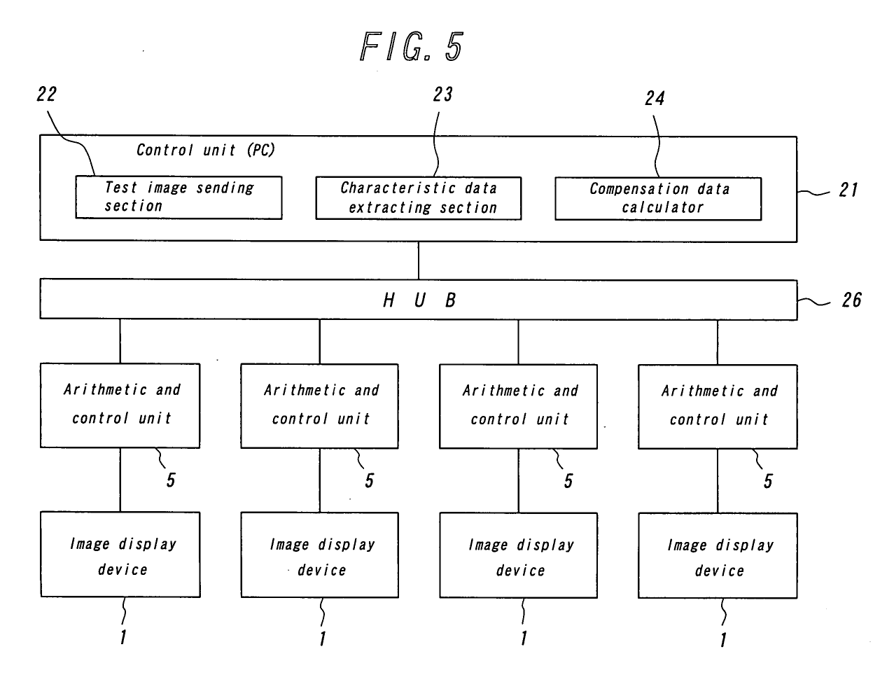

Therefore, as shown in FIG. 5 by a schematic diagram, a common control unit 21 is provided to all image display devices 1 to be combined. The control unit 21 is provided with a test image sending section 22, a characteristic data extracting section 23, and a compensation data calculator 24, the test image sending section 22 is switched and connected to the video signal input circuit 16 of respective arithmetic and control units 5, and the characteristic data extracting section 23 and the compensation data calculator 24 are connected to the communication section 15 of respective arithmetic and control units 5 through a hub (HUB) 26, in addition, the image signal from CCD camera is input to the characteristic data extracting section 23 as described later. The control unit 21 is constituted with, for example, a personal computer (PC).

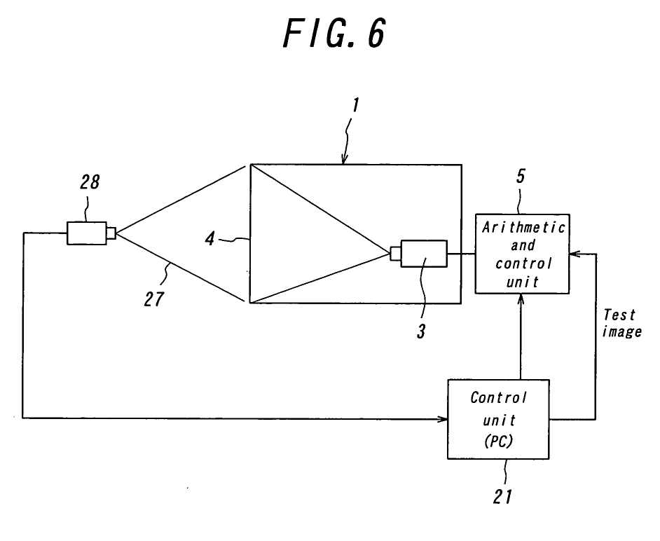

In this way, in order to obtain the characteristic data of the respective image display devices 1, as shown in FIG. 6, the through-mode command signal is given from the control unit 21 to the arithmetic and control unit 5, and the test video signal is sent from the test image sending section 22 of the control unit 21 to the video signal input circuit 16 of the arithmetic and control unit 5, the test image is supplied to the projector 3 without compensating and processing by the video signal correction processing unit 13 in a through-mode, thereby projecting and displaying the test signal on the screen 4, the display image of the full screen is captured with a CCD camera 28 by shading the outside light with a food 27, and the captured data is taken in to the characteristic data extracting section 23 of the control unit 21, thereby obtaining the characteristic data. Moreover, the food 27 is formed in such a manner that it is constituted with the material having an inner surface thereof, on which the light does not reflect, so as not to reflect the image of the screen 4 on the food 27.

Hereafter, the method of obtaining the characteristic data is explained more in detail. In respective image display devices 1, first, as a through-mode, the test image of only R (red) color is lightened in step wise, for example, from the input level 0(black) to the input level 255(red) represented by 256 steps (8 bits), that is, from 0% luminance to 100% luminance, in each case, the display image is captured with the CCD camera 28, and the captured data is taken in to the characteristic data extracting section 23 of the control unit 21.

Here, the step of the input level of the test image can be made every 16 input levels, for example, 0, 16, 32, 48 . . . 240, and 255, or in the case of the γ coefficient of real input image being 0.45, there is a tendency that the input level of a black image may be put weight on, and the input level of a white image may be made comparative rough, so that, for example, the black image can be made fine, such as 0, 4, 8, 12, 16, 24, 32, 40, 48, 64, 96, 128, 160, 192, 224, 255, and the white image can be made rough a little.

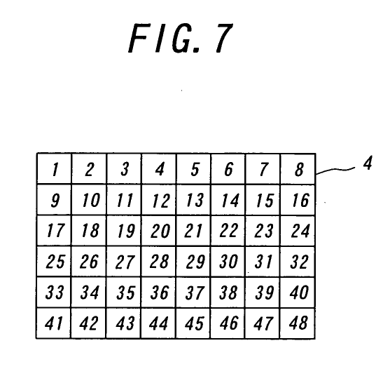

In the characteristic data extracting section 23, as shown in FIG. 7, the display area of the screen 4 is divided into a plurality of blocks, and the luminance value of respective blocks is calculated at each input level, based on the captured data, thereby obtaining R color characteristic data. Moreover, the case that the display area is divided into 48 blocks (transversal 8 and vertical 6) in total is shown in FIG. 7, but the number of partitions at the block may be set according to the request level of the image quality. For example, in the case that the projector 3 is SVGA, the display area can be divided into 480,000 blocks (transversal 800 and vertical 600) in total in maximum at each pixel, and in the case that the projector 3 is SXGA (1280×1024), 16×16 is as one block, the display area can be divided into 5,120 blocks (transversal 80 and vertical 64) in total.

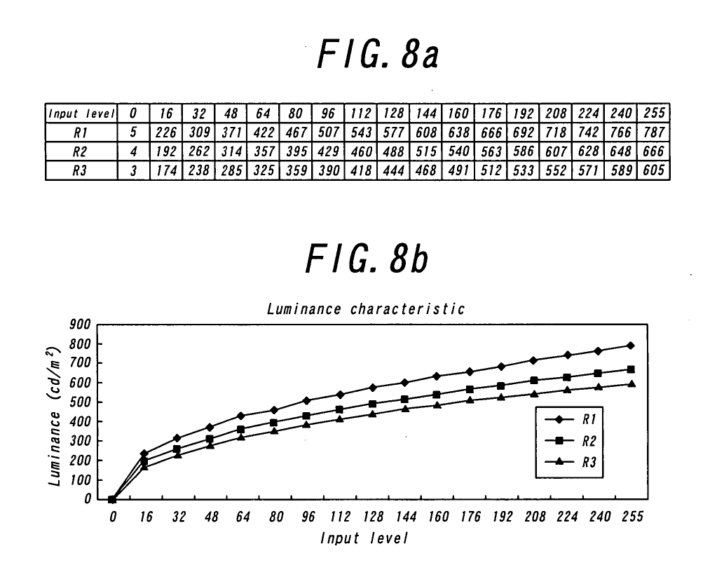

FIG. 8 shows one embodiment of the characteristic data of R color capable of being obtained by the above process, and FIG. 8(b) is a graph showing FIG. 8(a). In FIG. 8, R1 shows a luminance value (cd/m²) of the first block, R2 shows a luminance value of the second block, R3 shows a luminance value of the third block, and the luminance value of other blocks is omitted.

As to G color and B color, in the same way, the characteristic data is calculated, the characteristic data of the respective colors of these R, G, and B are transmitted to the arithmetic and control unit 5 of the image display device 1 through the hub 26, thereby storing the data in the characteristic data memory unit 11. In this way, the characteristic data of respective colors in each R, G, and B of the four image display devices 1, are calculated, thereby storing the data in the characteristic data memory unit 11 of the corresponding arithmetic and control unit 5.

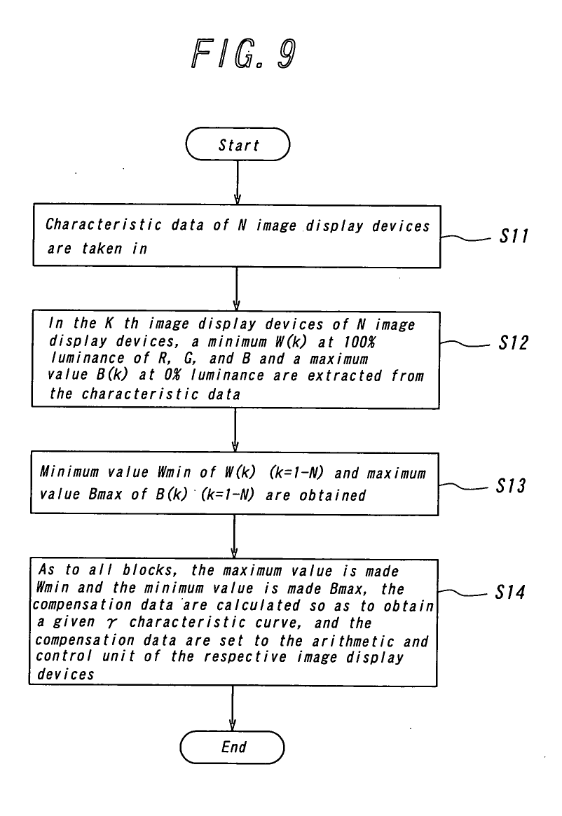

Next, the method of calculating the compensation data is explained more in detail with reference to a flow chart shown in FIG. 9. First, the characteristic data of N image display devices 1, that is, the characteristic data stored in the characteristic data memory unit 11 of all arithmetic and control units 5 are taken in to the compensation data calculator 24 of the control unit 21 (step S11). Afterwards, in the compensation data calculator 24, the characteristic data are compared as to respective colors of R, G, and B in k (k=1-N) th image display devices 1, and the minimum value W(k) of luminance in capture of the image in 100% intensity and the maximum value B(k) of luminance in capture of the image in 0% intensity are extracted (step S12). Next, the reference data Wmin of the upper limit being a minimum value of W(k) (k=1-N) and the reference data Bmax of the lower limit being a maximum value of B(k) (k=1-N), are extracted (step S13).

That is, in step S12, the minimum value R-White(k), G-White(k), and B-White(k), at 100% luminance of respective colors in the image display device 1 of k(k=1-4)th, and the maximum value R-Black(k), G-Black(k), and B-Black(k), at 0% luminance are extracted, and in step S13, the reference data Wmin of upper lmit (R-White(k), G-White(k), and B-White(k) (k=1-N), ) being the minimum value of R-Whitemin, G-Whitemin, and B-Whitemin, and the reference data Bmax of lower limit (R-Blackmax, G-Blackmax, and B-Blackmax) being the maximum value of R-Black(k), G-Black(k), and B-Black(k) (k=1-N), are extracted.

Afterwards, as to all blocks of respective image display devices 1, the compensation data are calculated in such a manner that 100% luminance of respective colors becomes reference data Wmin in the upper limit, 0% luminance becomes reference data Bmax in the lower limit, and a required characteristic curve is obtained, and the compensation data are set to the arithmetic and control unit 5 of the corresponding image display device 1 (step S14).

That is, in step S14, first, R-Whitemin, G-Whitemin, B-Whitemin, R-Blackmax, G-Blackmax, and B-Blackmax are used respectively as reference data in the upper limit and as reference data in the lower limit, the correction factor is calculated in such a manner that other characteristic data are made consistent to the reference data, and the luminance value of respective blocks is corrected by the correction factor. That is, as to all blocks, the characteristic data are corrected in such a manner that the luminance value in the image of 0% intensity and the luminance value in the image of 100% intensity are made consistent to respective reference data.

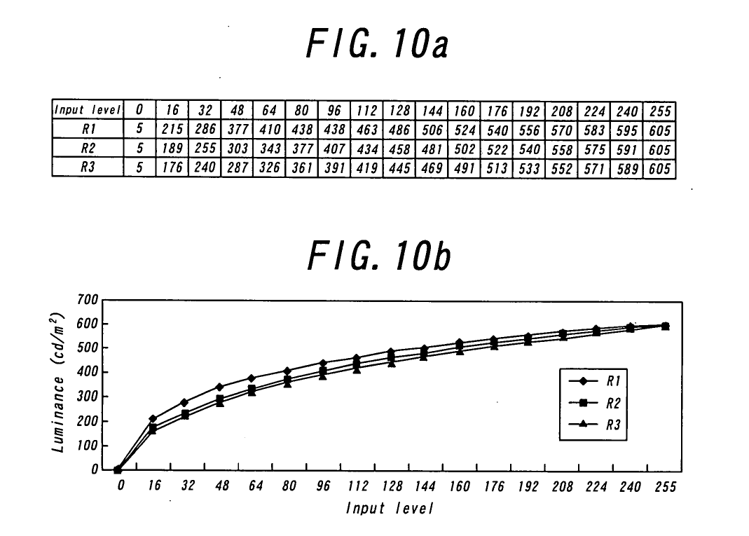

FIG. 10 shows one embodiment of the correction characteristic data of R color capable of being obtained by the above correction process of the characteristic data, and FIG. 10(b) is a graph showing FIG. 10(a). Same as in the case of FIG. 8, FIG. 10 shows as to the block from first to third, and the other blocks are omitted.

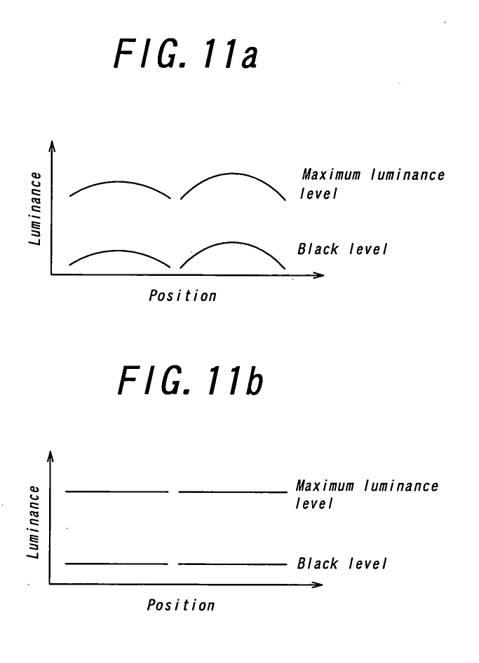

In this way, as shown in FIG. 11(a), even if there have a luminance distribution, in which the black level (input level 0) and the maximum luminance level (input level 255) of respective image display devices 1 are different in the horizontal direction or in the vertical direction, these levels can be equated as shown in FIG. 11(b). Moreover, FIG. 11 shows a black level and a maximum luminance level of two image display devices.

However, as is seen from FIG. 10, as to all blocks, even if the characteristic data are corrected in such a manner that respective luminance values of input level 0 and input level 255 are made consistent to the extracted reference data, if the ãcoefficient of respective blocks is different, the luminance value in the half tone is not necessarily consistent.

Then, in step S14, in addition, as to all blocks, the compensation data with a consistent γ coefficient is calculated. Concretely, every respective colors of R, G, and B, the average of the γ characteristic curve is calculated, and the correction factor becoming the average γ characteristic curve (given γ characteristic curve) at every blocks, that is, the compensation data, is calculated.

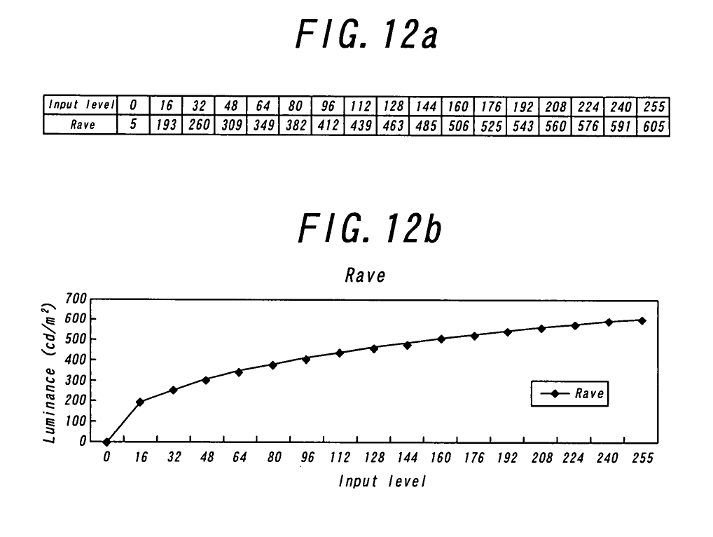

In this way, as shown in FIG. 12, the luminance value in respective input levels can be consistent as to all blocks. Moreover, FIG. 12 shows a corrected result Rave of R color, and FIG. 12(b) is a graph showing FIG. 12(a).

As explained above, the compensation data for making the luminance and the a characteristic curve consistent are calculated by a single arithmetic processing, and the obtained compensation data of respective image display devices 1 are delivered to the corresponding arithmetic and control unit 5, thereby storing the compensation data in the compensation data memory unit 12 by the lookup table (LUT) system, in which the block and the compensation data are corresponded to each other.

Afterwards, the image output device 6 is connected to the video signal input circuit 16 of respective arithmetic and control units 5 as shown in FIG. 2, and the input video signal from the image output device 6 is corrected and processed by the video signal correction processing unit 13 and projected and displayed on the screen 4 by the projector 3, based on the compensation data stored in the compensation data memory unit 12, thereby displaying one screen with four image display devices 1.

According to the present embodiment, as to N image display devices 1 to be combined, in order to obtain the characteristic data of every one image display device, the test image is previously projected, the projected image is captured with the CCD camera 28, the characteristic data are calculated from the captured data and are stored in the characteristic data memory unit 11 of the corresponding arithmetic and control unit 5, in case of installing N image display devices 1, the compensation data of respective image display devices 1 are collectively operated based on those characteristic data, the compensation data are stored in the compensation data memory unit 12 of the corresponding arithmetic and control unit, so that the irregularity of the intra-screen and the inter-screen in N image display devices 1, that is, the irregular luminance and the irregular color, the white balance, and the ãproperties can be adjusted at a time.

Moreover, the characteristic data of respective image display devices 1 are also stored in the characteristic data memory unit 11 by measuring the data at, for example, the factory excluding the installation site. In this way, the measuring at the installation site becomes unnecessary, so that even in the case that the CCD camera 28 can not be installed at the installation site, and the installation environment can not be made a darkroom, the adjustment of the intra-screen irregular and the inter-screen irregular becomes possible.

In addition, in the case of exchanging one of image display devices 1 by the failure etc., the characteristic data of exchanged image display device 1 is taken in, and the entire adjustment can be promptly performed by calculating the compensation data again. Moreover, in the case that the irregularity has stood out by the fact that the lamp light quantity of the projector 3 is decreased with time, or the projector 3 is made of a liquid crystal projector, and the characteristic of the liquid crystal panel is changed, the characteristic data can be updated by fitting the small food 27 to each of the image display devices 1, so that even in the case that the measuring space is narrow, and the entire multiple-screen display can not be made a darkroom, the adjustment becomes possible.

Moreover, in this embodiment, in obtaining the characteristic data, the test image is captured with the CCD camera 28 and the captured data for whole screen is obtained, but, the captured data for whole screen is obtained with a video camera in place of the CCD camera 28, or the whole screen is also scanned by using the colorimetric machine and the photo-electronic sensor, thereby being able to obtain the capturing data.

### Second Embodiment

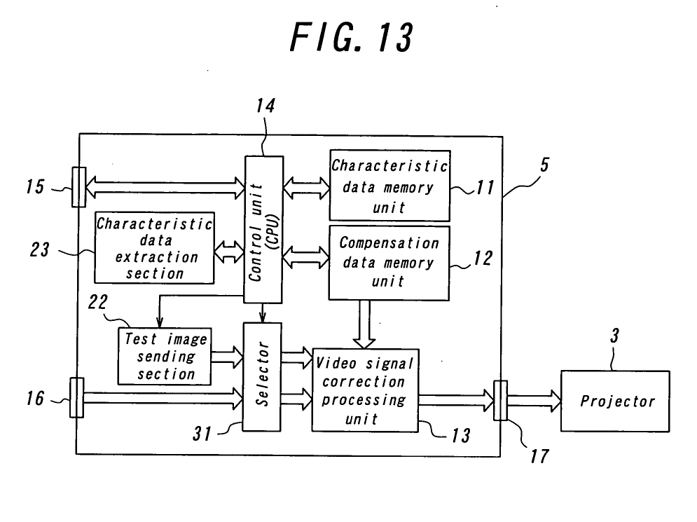

FIG. 13 is a view showing the constitution of the principal portion in the second embodiment of the present invention. The present embodiment is so constructed that in the first embodiment, the test image sending section 22 and the characteristic data extracting section 23 of the control unit 21 are omitted, these sections are installed in the arithmetic and control unit 5 corresponding to respective image display devices 1, the test image from the test image sending section 22 and the input video signal from the video signal input circuit 16 are switched by a selector 31.

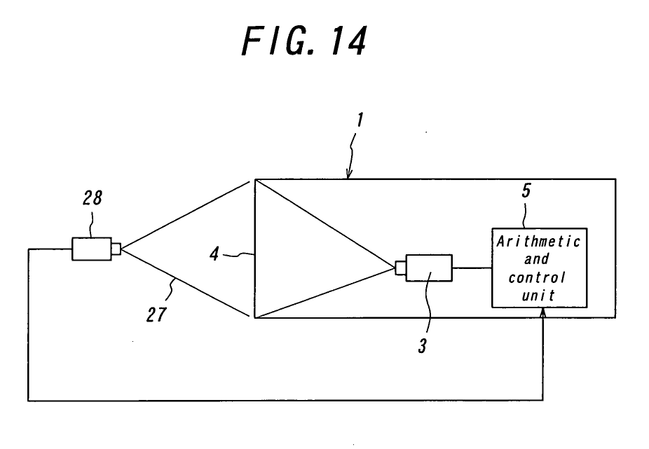

In this way, when the characteristic data are obtained, the test image is sent from the test image sending section 22, under the control of control unit 14, the test image is supplied to the video signal output section 17 in through-mode, thereby projecting and displaying the test image on the screen 4 by the projector 3, without correcting the test signal by the video signal correction processing unit 13 through the selector 31. The test image displayed on the screen 4 shades the outside light by the food 27 and is captured with the CCD camera 28 as shown in FIG. 14, the captured data is taken in the characteristic data extracting section 23 through the communication section 15 and control unit 14, and the characteristic data is extracted, and stored in the characteristic data memory unit 11.

After obtaining the characteristic data in all image display devices 1, as in the same as the first embodiment, the compensation data of respective image display devices 1 are calculated by the control unit 21, thereby storing the compensation data in the compensation data memory unit 12 of the corresponding arithmetic and control unit 5.

In this way, if the test image sending section 22 and the characteristic data extracting section 23 are accommodated in the arithmetic and control unit 5 of respective image display devices 1, in individual image display device 1, the display of test image, the capturing, and the extracting and preservation of the characteristic data for obtaining the characteristic data can be automatically performed according to arbitrary timing, so that the acquiring operation of the characteristic data becomes easy. Moreover, the test image sending section 22 and the characteristic data extracting section 23 need not be provided to the control unit 21, so that the constitution can be simplified for it.

### Third Embodiment

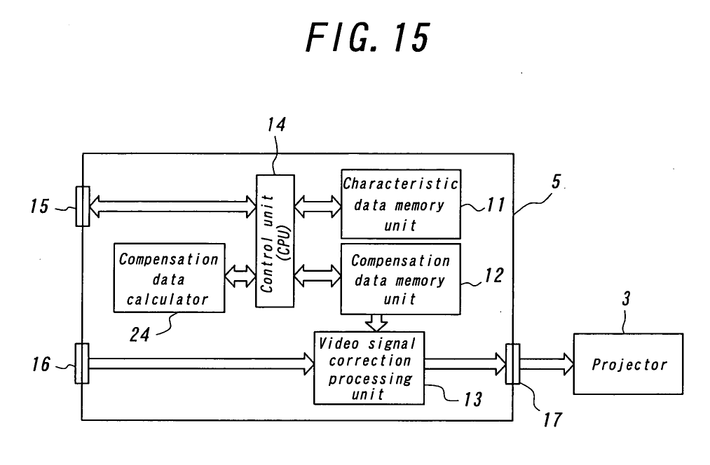

FIG. 15 is a block diagram showing the principal portion in the third embodiment of the present invention. In the present embodiment, the compensation data calculator 24 of the control unit 21 in the first embodiment is omitted, and the compensation data calculator 24 is built-in the arithmetic and control unit 5 corresponding to respective image display devices 1.

In this way, in the case of calculating the compensation data, under the condition that all arithmetic and control units 5 are mutually connected communicably through the hub 26, the characteristic data stored in the characteristic data memory unit 11 of all arithmetic and control units 5 is taken in the compensation data calculator 24 of respective arithmetic and control units 5 including the characteristic data stored in its own characteristic data memory unit 11, and as in the same as the first embodiment, the its own compensation data are calculated and stored in the corresponding compensation data memory unit 12, based on those characteristic data.

Moreover, in this case, the characteristic data took in from other arithmetic and control units 5, may be acceptable only a minimum value at 100% luminance and a maximum value at 0% luminance, respectively, that is, only R-White, G-White, B-White, R-Black, G-Black, and B-Black.

In this way, if the compensation data calculator 24 is built-in the arithmetic and control unit 5 of respective image display devices 1, in respective image display devices 1, its own compensation data can be calculated while communicating to other arithmetic and control units 5 at arbitrary timing. Moreover, the compensation data calculator 24 need not be provided to the control unit 21, so that the constitution can be simplified for it.

### Fourth Embodiment

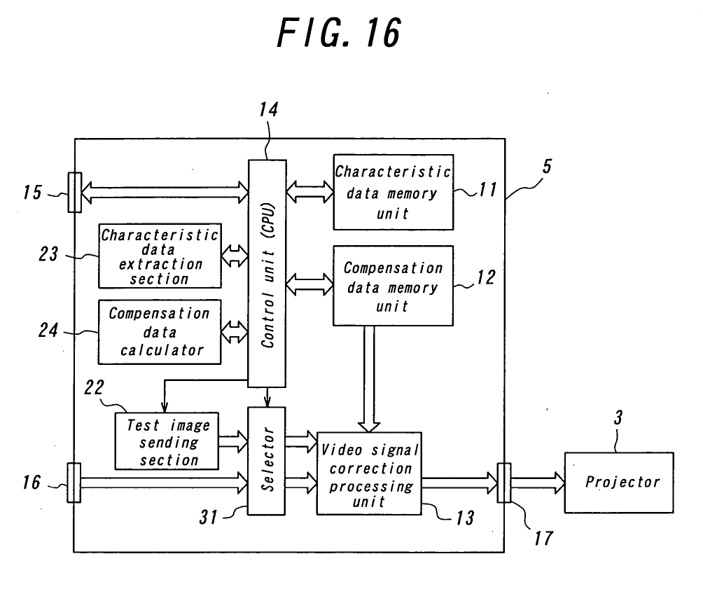

FIG. 16 is a block diagram showing the principal portion in the fourth embodiment of the present invention. The present embodiment builds-in the compensation data calculator 24 in the arithmetic and control unit 5 corresponding to respective image display devices 1 in the second embodiment, as in the same as the third embodiment, the its own compensation data are calculated and stored in the corresponding compensation data memory unit 12.

Moreover, in this case, the characteristic data took in from other arithmetic and control units 5, may be acceptable only R-White, G-White, B-White, R-Black, G-Black, and B-Black, as the same as in the third embodiment.

In this way, in respective image display devices 1, the obtaining process of the characteristic data and the calculation process of the compensation data can be performed according to the arbitrary timing, and the above described control unit 21 becomes unnecessary, and thus the simplification of the system configuration can be attempted.

### Fifth Embodiment

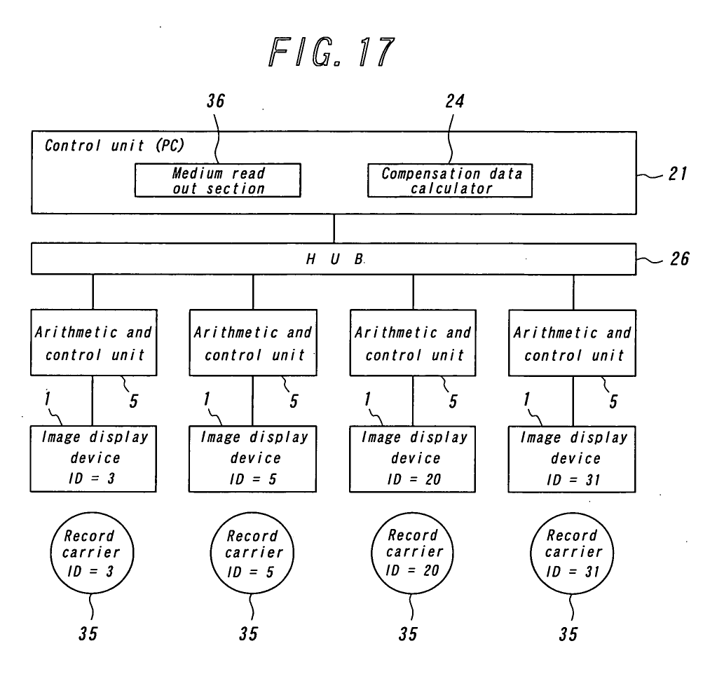

FIG. 17 is a view explaining the fifth embodiment according to the present invention. In the present embodiment, a portable record carrier 35, such as CD-R is accompanied with respective image display devices 1. The characteristic data of the corresponding image display device 1 is recorded in the record carrier 35 together with the identification code (ID) of the image display device 1 by measuring the data, for example, at the factory etc. previously.

On the other hand, the control unit 21 is provided with a record medium reading section 36 for reading the record carrier 35 and the compensation data calculator 24.

In this way, the arithmetic and control unit 5 and the control unit 21 of all image display devices 1 are connected with each other through the hub 26, all record carriers 35 are sequentially read by medium reading section 36 of the control unit 21, based on the thus obtained characteristic data and identification code of all image display devices 1, as in the same as the first embodiment, the compensation data of respective image display devices 1 are collectively calculated, and thus the corrected data is stored in the compensation data memory unit 12 of the corresponding arithmetic and control unit 5, together with the identification code.

Moreover, in the present embodiment, the characteristic data read by the record medium reading section 36 is supplied directly to the compensation data calculator 24, and then the characteristic data memory unit 11 of respective arithmetic and control units 5 can be omitted, but, the medium reading section 36 is stored in the characteristic data memory unit 11 of the arithmetic and control unit 5 based on the identification code, and the stored characteristic data can also be calculated by taking in the compensation data calculator 24, thereby calculating the compensation data. Particularly, as in the latter, if the data read from the record carrier 35 is stored in the corresponding characteristic data memory unit 11, in the case of exchanging the arbitrary image display device 1, the record carrier 35 of the image display device 1 which is not exchanged, need not be read again.

According to the present embodiment, the characteristic data of respective image display devices 1 are for example previously recorded in the portable record carrier 35 at the factory etc. together with the identification code, and are accompanied, so that the measuring at the installation site becomes un-necessary. Therefore, in even the camera can not be installed to the installation site, and the installation environment can not be made a darkroom, the compensation data can be calculated, respective image display devices 1 can be adjusted.

### Sixth Embodiment

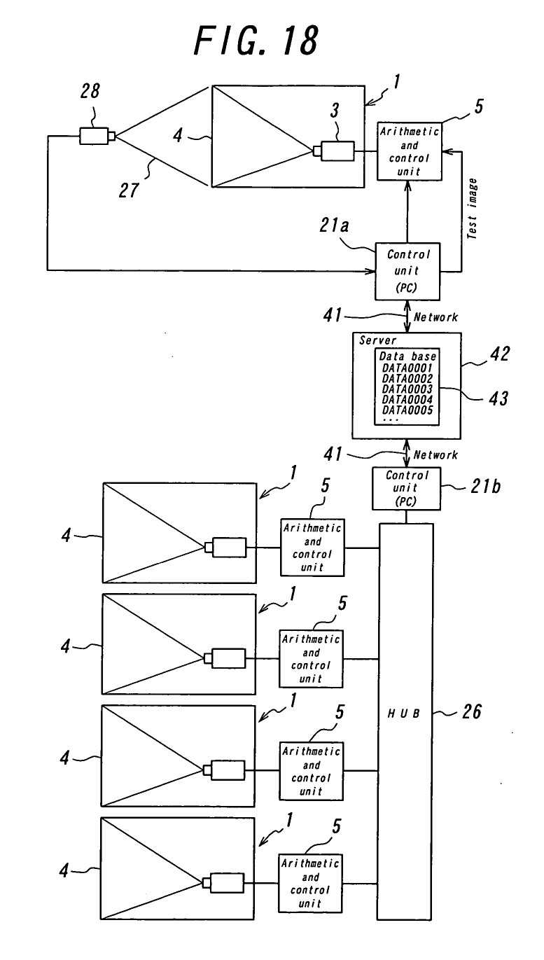

FIG. 18 is a view explaining the sixth embodiment according to the present invention. In this embodiment, a server 42 is provided accessibly by the control unit 21a, the control unit 21b, and a network 41, and the server 42 is provided with a data base 43 for the characteristic data. Moreover, the arithmetic and control unit 5 corresponding to the respective image display devices 1 is constituted as in the case shown in FIG. 3, but the characteristic data memory unit 11 is omitted.

The control unit 21a is installed for example to the factory etc. The control unit 21a is provided with the test image sending section, the characteristic data calculator, and the communication section, the characteristic data of the manufactured image display device 1 is measured as explained in FIG. 6, and the characteristic data is stored in a data base 43 of the server 42 through the network 41 together with the identification code of the image display device 1.

Moreover, the control unit 21b is arranged at the installation site side of the multiple-screen display. The control unit 21bis provided with the compensation data calculator and the communication section and is connected accessibly to the server 42 through the network 41, and is connected communicably to the arithmetic and control unit 5 of respective image display devices 1 constituting the multiple-screen display through the hub 26.

In this way, in order to obtain the compensation data of all image display devices 1 constituting the multiple-screen display, the control unit 21b and the server 42 are connected through the network 41, the corresponding characteristic data is retrieved from the data base 43 based on the identification code of the image display device 1 to be used, to take in the compensation data calculator of the control unit 21b, in the same way as described above, the compensation data of respective image display devices 1 are calculated, based on all the took in characteristic data, and thus the calculated compensation data is stored in the compensation data memory unit 12 of the corresponding arithmetic and control unit 5, together with the identification code.

According to the present embodiment, the characteristic data of respective image display devices 1 is stored in the data base 43 of the accessible server 42 through the network 41, together with the identification code, for example, at the manufacturing time, thereby performing central control, so that the image display device 1 need not be chosen beforehand, the compensation data can be calculated at once by taking out those characteristic data of data base 43 based on those identification codes, at the time of deciding the combination of arbitrary image display devices 1, and thus the installation time can be shortened considerably.

Moreover, in the case of exchanging a part of image display devices 1 by the failure etc., the characteristic data of the exchanged image display device 1 are taken in from the data base 43, and the entire adjustment can be promptly performed by calculating the compensation data again.

### Seventh Embodiment

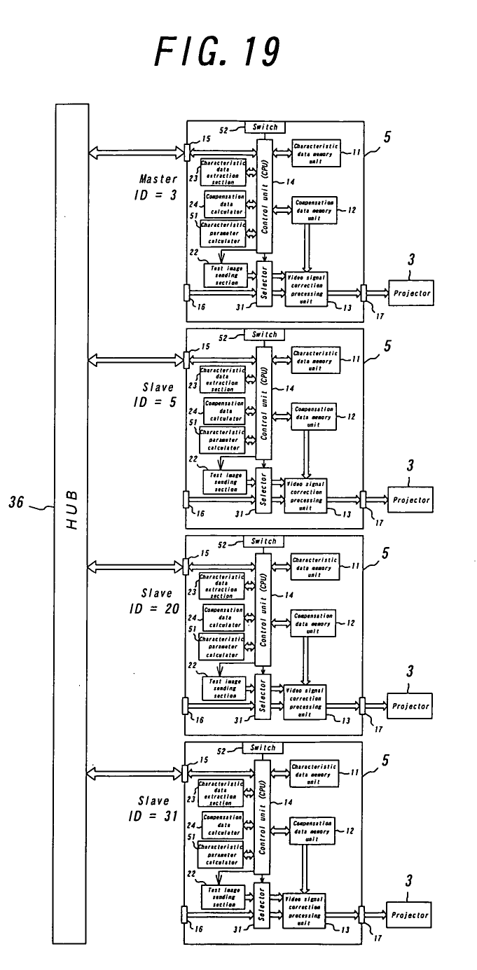

FIG. 19 is a view explaining the seventh embodiment according to the present invention. In this embodiment, the arithmetic and control unit 5 corresponding to the respective image display device 1 is constituted by adding the characteristic parameter calculator 51 and the switch 52 being the process start instruction means to the constitution shown in FIG. 16.

As in the case of second embodiment and fourth embodiment, the characteristic data of respective image display devices 1 is individually obtained by sending the test video signal from the test image sending section 22 built in the corresponding arithmetic and control unit 5.

Moreover, as shown in FIG. 19, the compensation data of respective image display devices 1 are calculated under the condition of connecting all arithmetic and control units 5 mutually by the hub 26 communicably, thereby storing the data in the compensation data memory unit 12 of the corresponding arithmetic and control unit 5.

In this embodiment, the image display device 1 corresponding to the arithmetic and control unit 5 is assumed to be a master, and the image display device 1 corresponding to other arithmetic and control units 5 is assumed to be a slave, by making the switch 52 of the arbitrary arithmetic and control unit 5 actively (on), and then the compensation data of respective image display device 1 is calculated.

That is, first, the master operates the characteristic parameter by taking in the characteristic data stored in the characteristic data memory unit 11 of all arithmetic and control units 5 including the characteristic data stored in its own characteristic data memory unit 11 in own characteristic parameter calculator 51.

Here, the characteristic data taking in the characteristic parameter calculator 51 of the master, takes in all characteristic data from the own characteristic data memory unit 11, but the characteristic data taking in the characteristic parameter calculator 51 of the master, takes in at least a minimum value at 100% luminance and a maximum value at 0% luminance, that is, R-White, G-White, B-White, R-Black, G-Black, and B-Black from the respective characteristic data memory units 11 of the slave.

Afterwards, in a characteristic parameter calculator 51 of the master, the reference data Wmin (R-Whitemin, G-Whitemin, B-Whitemin) for the upper limit and the reference data Bmax (R-Blackmax, G-Blackmax, B-Blackmax) for the lower limit are extracted based on the taken-in characteristic data, and the average γ characteristic curve of respective colors is calculated based on the characteristic data of all blocks of those reference data and masters, and thus these γ characteristic curves are supplied to own compensation data calculator 24 and compensation data calculator 24 of respective slaves as a characteristic parameter.

Afterwards, for a master and respective slaves, in the respective compensation data calculators 24, the compensation data are calculated to store in the corresponding compensation data memory unit 12, based on the supplied characteristic parameter and the characteristic data of all blocks stored in the corresponding characteristic data memory unit 12.

According to the present embodiment, by operating a switch 52 of the arbitrary arithmetic and control unit 5, the characteristic parameters of all image display devices 1 to be combined are calculated by the master by the master-slave system and are supplied to the slave, thereby arithmetically operating the compensation data, based on characteristic parameter and its own characteristic data in respective arithmetic and control units 5 of the master and the slave, so that for example, in the case of exchanging a part of the image display device 1 by the failure etc., the compensation data can be calculated again by operating the switch 52 of the arithmetic and control unit 5 of the exchanged image display device 1, and thus the entire adjustment can be promptly performed.

### Eighth Embodiment

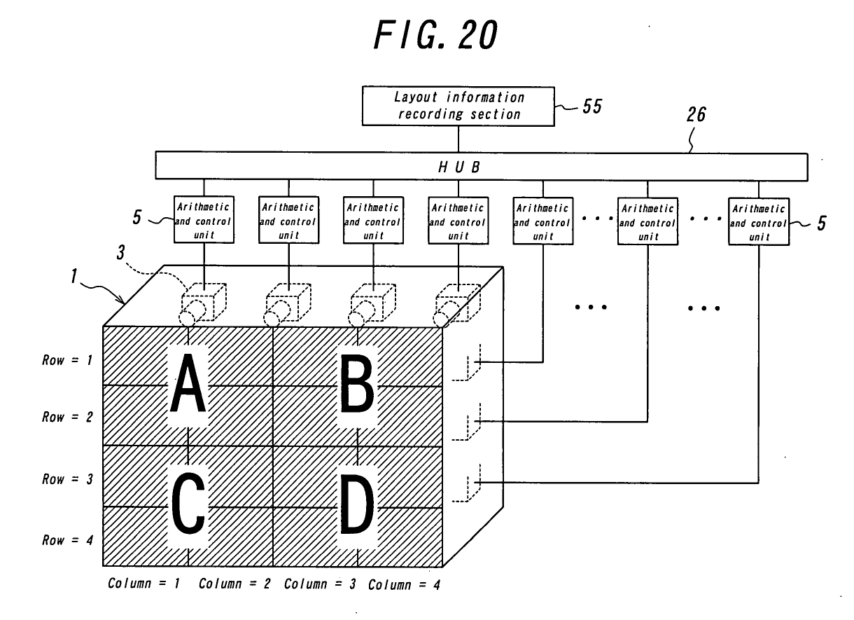

FIG. 20 is a view explaining the eighth embodiment according to the present invention. The multiple-screen display is formed by combining 16 image display devices 1 with 4×4, four blocks of A, B, C, and D are formed with four image display devices 1 of 2×2 respectively, the independent image is displayed respectively in respective blocks.

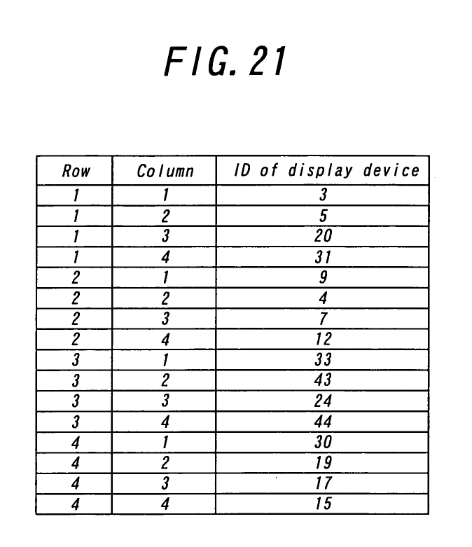

Therefore, in this embodiment, the arithmetic and control unit 5 is connected to the respective image display devices 1 respectively, and these display devices are connected to the hub 26, and a layout information memory section 55 is provided to the hub 26, and then the layout information showing the layout position of 16 image display devices 1 is for example stored in the layout information memory section 55 by using for example the identification code (ID) of respective image display devices 1 as shown in FIG. 21.

In this way, the compensation data are obtained, same as in the above described embodiment, at every the block of A, B, C, and D consisting of four image display devices 1, respectively, based on the layout information stored in the layout information memory section 55, the data are stored in the compensation data storage section 12 of the corresponding arithmetic and control unit 5, thereby performing the luminance matching and the color matching at every block.

In this way, in the present embodiment, even if the multiple-screen display has 16 image display devices 1, four image display devices 1 each displaying an independent image, are assumed as one block (multiple-screen display) thereby performing the luminance matching and the color matching, so that an average contrast can be improved compared with the case that 16 image display devices 1 are assumed as one multiple-screen display, thereby performing the luminance matching and the color matching.

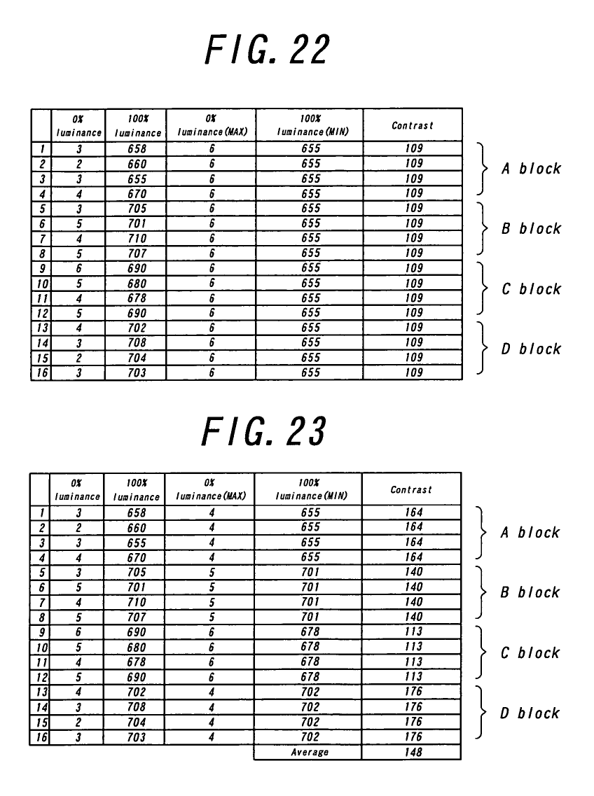

For example, if the maximum value of 0% luminance and the minimum value of 100% luminance of each of 16 image display devices 1 have the value as shown in FIG. 22, when the compensation data is calculated and corrected from the characteristic data of all of 16 image display devices, the maximum value of 0% luminance of all of 16 image display devices 1 (0% luminance (MAX)) becomes “6”, and the minimum value of 100% luminance (100% luminance (MIN)) becomes “655”, so that all of the contrasts of A block-D block become “109”.

On the contrary, as in the present embodiment, if the compensation data are calculated at every blocks, as shown in FIG. 23, in A block, 0% luminance (MAX) becomes “4” and 100% luminance (MIN) becomes “655” and the contrast becomes “164”, in B block, 0% luminance (MAX) becomes “5” and 100% luminance (MIN) becomes “701” and the contrast becomes “140”, in C block, 0% luminance (MAX) becomes “6” and 100% luminance (MIN) becomes “678” and the contrast becomes “113”, and in D block, 0% luminance (MAX) becomes “4” and 100% luminance (MIN) becomes “702” and the contrast becomes “176”. Therefore, the average contrast thereof becomes “148”, and thus this value can be raised more than the case adjusted by whole 16 image display devices.

Moreover, in the above respective embodiments, in the case of calculating the compensation data, reference data Wmin of the upper limit for respective colors are made independent as R-Whitemin, G-Whitemin, and B-Whitemin, but these reference data can also be assumed to be one (G-Whitemin for example) of, for instance, R-Whitemin, G-Whitemin, and B-Whitemin reference data, and can also be assumed to be average value thereof. The color reference data Bmax of the lower limit for respective colors can be made to be one, similarly.

### Ninth Embodiment

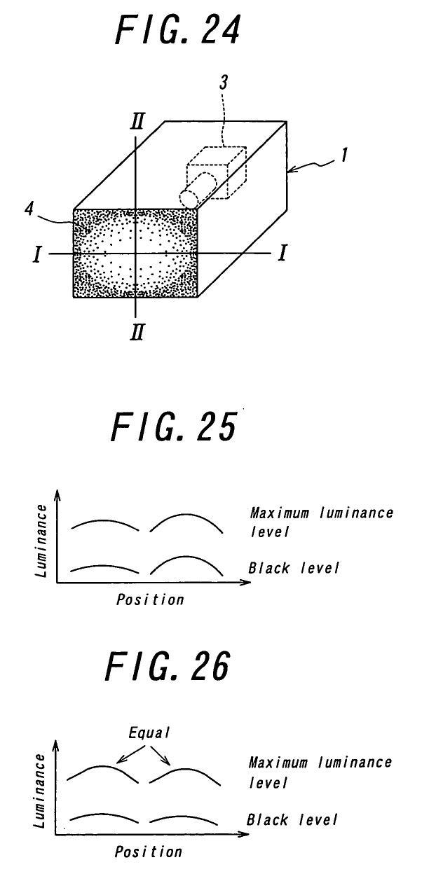

FIGS. 24-28 are views explaining the ninth embodiment according to the present invention. In this embodiment, the compensation data of respective image display devices are calculated, in such a manner that the output characteristic of the N image display devices is made equal, and right and left, as well as upper and lower output characteristics of the screen are made to be a subject in respective image display devices, from the characteristic data of the plural N of image display devices constituting multiple-screen display.

That is, as shown in FIG. 24, if the test image of 0% luminance or 100% luminance is displayed on the screen 4 of one image display device 1, there is a case that the center portion of the screen becomes bright and the periphery portion thereof becomes dark. Moreover, there are a lot of cases that the luminance distributions in the horizontal direction or the vertical direction are different in each image display device. Therefore, when the N image display devices are arranged, a black level and a maximum luminance level in those horizontal directions or vertical directions become for example as shown in FIG. 25. Moreover, FIG. 25 shows the luminance distribution of two image display devices.

In this case, when the whole area in the screen is corrected to the same luminance, the center section thereof becomes darkened and the contrast thereof becomes decreased, so that there is a case that it may be prevented from being decreased in contrast by decreasing the correction of the center section.

Then, in this embodiment, the compensation data is calculated in such a manner that the output characteristic of the respective image display devices may become equal as shown in FIG. 26, based on the characteristic data of the plural N of image display devices. In this way, the luminance level for the boundary portion of adjacent image display devices is consistent, so that the difference of the luminance between the screens can be eliminated, and the joint of screens can be made unremarkable.

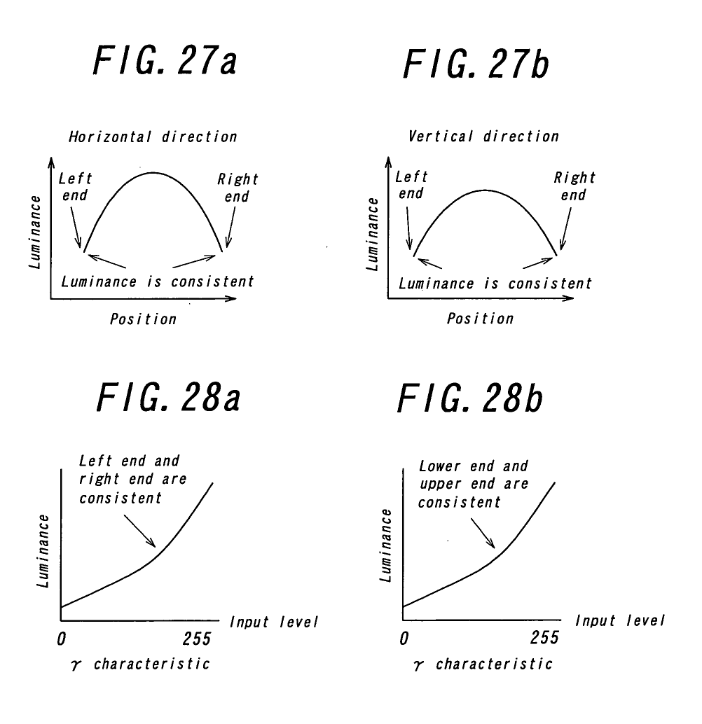

Moreover, in order that the irregular luminance and the irregular color for the boundary between image display devices are made unremarkable, the characteristic of luminance and the color for the boundary portion must be made consistent, so that in respective image display devices, a horizontal luminance distribution shown in FIG. 24 by I-I line, is made consistent in luminance at right and left ends and is made bilateral symmetry as shown in FIG. 27(a), and a vertical luminance distribution shown in FIG. 24 by II-II line, is made consistent in luminance at upper and lower ends and is made a symmetry between the under and lower halves, as shown in FIG. 27(b), and then as shown in FIGS. 28(a) and 28(b), the γ characteristic of right and left ends and the γ characteristic of upper and lower ends are made consistent, and thus the luminance deviation and the color blur in the half tone are prevented. Moreover, if the luminance at the center of respective image display devices is made consistent, the inter-screen luminance difference can be made unremarkable, but in the case that wants to avoid the decrease in the contrast, the luminance at the center of the screen may not be made consistent.

What is claimed is:

1. A multiple-screen display having one-screen constituted by combining plural N of image display devices, comprising a characteristic data memory means, a compensation data memory means, and a video signal correction processing means, corresponding to respective image display devices, and a compensation data calculator means common with plural N of image display devices, the characteristic data of the corresponding image display device being stored in the characteristic data memory means, the compensation data calculator means being constituted in such a manner that the compensation data of respective image display devices are calculated collectively, based on the characteristic data stored in all characteristic data memory means, to store these compensation data in the corresponding compensation data memory means, and the input video signals being displayed by compensating and processing them in respective image display devices, by the video signal correction processing means, based on the compensation data stored in the corresponding compensation data memory means.

2. A multiple-screen display having one-screen constituted by combining plural N of image display devices, comprising a characteristic data memory means, a compensation data calculator means, a compensation data memory means, a communication means and a video signal correction processing means, corresponding to respective image display devices, the characteristic data of the corresponding image display device being stored in the characteristic data memory means, all image display devices being able to be connected with mutual communicable through the communication means, the compensation data calculator means is constituted in such a manner that the characteristic data stored in the characteristic data memory means of all image display devices are taken in, and the compensation data of the corresponding image display means are calculated based on these characteristic data, to store these compensation data in the compensation data memory means, and the input video signals being displayed by compensating and processing them in respective image display devices, by the video signal correction processing means, based on the compensation data stored in the corresponding compensation data memory means.

3. A multiple-screen display having one-screen constituted by combining plural N of image display devices, comprising a compensation data memory means, a video signal correction processing means and a portable record carrier, corresponding to respective image display devices, and a compensation data calculator means having a record carrier reading function and common with N image display devices, the characteristic data of the corresponding image display device and the identification code of said image display device are recorded in the record carrier, the compensation data calculator means is constituted in such a manner that the compensation data of respective image display devices are calculated collectively, based on the characteristic data obtained by reading all record carriers and identification codes, to store these data and codes in the corresponding compensation data memory means, and the input video signals being displayed by compensating and processing them in respective image display devices, by the video signal correction processing means, based on the compensation data stored in the corresponding compensation data memory means.

4. A multiple-screen display having one-screen constituted by combining plural N of image display devices, comprising a compensation data memory means, and a video signal correction processing means, corresponding to respective image display devices, a data base accessible through the network, and a compensation data calculator means capable of being connected to the networks and common with the N image display devices, the characteristic data of respective image display devices and the identification code of said image display device are recorded in the data base, the compensation data calculator means is constituted in such a manner that the compensation data of respective image display devices are calculated collectively, to store the compensation data in the compensation data memory means, based on the read information obtained by reading all characteristic data and identification codes from the data base through the network, and the input video signals being displayed by compensating and processing them in respective image display devices, by the video signal correction processing means, based on the compensation data stored in the corresponding compensation data memory means.

5. A multiple-screen display having one-screen constituted by combining plural N of image display devices, comprising a characteristic data memory means, a compensation data calculator means, a compensation data memory means, a communication means, a video signal correction processing means, and a process start instruction means, corresponding to respective image display devices, the characteristic data of the corresponding image display device being stored in the characteristic data memory means, all image display devices being able to be connected with mutual communicable through the communication means, the image display device corresponding to the said process start instruction means being assumed to be a master, and other image display means being assumed to be a slave, by activating the process start instruction means in the arbitrary image display device, the characteristic data stored in the characteristic data memory means of all image display devices are taken in by the means for calculating the characteristic parameter of the above master, and the characteristic parameter of respective image display devices is calculated collectively, and the calculated parameter is supplied to the compensation data calculator means of the corresponding image display device, the compensation data of the image display device being calculated to store these data in the corresponding compensation data memory means, based on the characteristic parameter supplied to the respective compensation data calculator means and on the characteristic data stored in the corresponding characteristic data memory means, and the input video signals being displayed by compensating and processing them in respective image display devices, by the video signal correction processing means, based on the compensation data stored in the corresponding compensation data memory means.

6. A multiple-screen display having one-screen constituted by combining plural N of image display devices, comprising a characteristic data memory means, a compensation data memory means, and a video signal correction processing means, corresponding to respective image display devices, a layout information memory means for storing the layout information showing the layout position of the N image display devices, a compensation data calculator means common with N image display devices, the characteristic data of the corresponding image display device being stored in the characteristic data memory means, the compensation data calculator means is constituted in such a manner that the compensation data of respective image display devices are calculated collectively, based on the characteristic data and layout information stored in all characteristic data memory means and the layout information memory means, respectively, to store these compensation data and layout information in the corresponding compensation data memory means, and the input video signals being displayed by compensating and processing them in respective image display devices, by the video signal correction processing means, based on the compensation data stored in the corresponding compensation data memory means.

7. A multiple-screen display as claimed in claim 2, wherein the identification codes of respective image display devices are stored in the layout information memory means.

8. A multiple-screen display as claimed in claim 1, wherein the characteristic data sequentially displays a specific image to the corresponding image display device by different luminance, and the characteristic of the respective display images is displayed by the image characteristic detecting means.

9. A multiple-screen display as claimed in claim 8, wherein the image characteristic detecting means contains any one of a CCD camera, a video camera, a colorimeter and a photo-electronic sensor.

10. A multiple-screen display as claimed in claim 1, wherein the characteristic data has the luminance value at plural input levels including 100% luminance and 0% luminance of respective colors of red (R), green (G), and blue (B) at every the block obtained by dividing the corresponding display area of the image display device into a plurality of blocks, the compensation data calculator means calculates the compensation data of respective colors of respective blocks collectively in such a manner that when the minimum values at 100% luminance of respective colors in k (k=1-N) th image display device are assumed to be R-White(k), G-White(k), and B-White(k), and the maximum values at 0% luminance are assumed to be R-Black(k), G-Black(k), and B-Black(k), minimum values R-Whitemin, G-Whitemin, and B-Whitemin of R-White(k), G-White(k), and B-White(k), (k=1-N), and maximum values R-Blackmax, G-Blackmax, and B-Blackmax of R-Black(k), G-Black(k), and B-Black(k), (k=1-N), are extracted, and in the case of R-Whitemin, G-Whitemin, and B-Whitemin at 100% luminance of a respective color of a respective image display device, and in the case of R-Blackmax, G-Blackmax, and B-Blackmax, at 0% luminance, a required γ characteristic curve is obtained.

11. A multiple-screen display as claimed in claim 10, wherein the given y characteristic curve is an average γ characteristic curve, in case of correcting the R-Blackmax, G-Blackmax, and B-Blackmax as lower limit, and in case of correcting the R-Whitemin, G-Whitemin, and B-Whitemin as upper limit.

12. A multiple-screen display as claimed in claim 10, wherein the R-Whitemin, G-Whitemin, and B-Whitemin and/or the R-Blackmax, G-Blackmax, and B-Blackmax are made equal.

13. A multiple-screen display as claimed in claim 11, wherein the R-Whitemin, G-Whitemin, and B-Whitemin and/or the R-Blackmax, G-Blackmax, and B-Blackmax are made equal.

14. A multiple-screen display as claimed in claim 1, wherein the compensation data calculator means calculates the compensation data in such a manner that the γ characteristic curve are made equal at the left end and the right end and at the upper end and the lower end of the display screen of respective image display devices.

15. A method of controlling a multiple-screen display having one-screen constituted by combining plural N of image display devices, comprising: a step of storing characteristic data obtained by capturing the screen of respective image display devices displayed by the test image previously, a step of calculating the compensation data of respective image display devices based on the characteristic data of the N image display devices after the layout of the plural N of image display devices, and a step of setting the calculated compensation data to respective image display devices.
